(19) United States
(12) Patent Application Publication
(10) Pub. No.: US 2019/0040841 A1
(43) Pub. Date: Feb. 7, 2019

(54) WAVE DRIVEN ELECTRICAL POWER GENERATION SYSTEM AND METHODS

(71) Applicant: Brimes Energy Inc., Holbrook, NY (US)

(72) Inventor: Ramuel Maramara, Ronkonkoma, NY (US)

(21) Appl. No.: 15/999,314

(22) PCT Filed: Feb. 17, 2017
(86) PCT No.: PCT/US2017/018409

§ 371 Date: Aug. 17, 2018

Related U.S. Application Data
(60) Provisional application No. 62/296,461, filed on Feb. 17, 2016.

(51) Int. Cl. F03B 13/18

(52) U.S. Cl. CPC F03B 13/1815; F05B 2260/406; F05B 2240/40; F03B 13/182

(57) ABSTRACT

A wave energy conversion system including a pod rotatably supported by a platform structure. The platform structure includes a horizontal stabilizing beam that is disposed in spaced relation to the pod and a plurality of vertical stabilizing beams. The plurality of vertical stabilizing beams is arranged in a spaced apart configuration and is configured to rotatably support the pod. The horizontal stabilizing beam is interposed between an outer pair of the plurality of vertical stabilizing beams opposite the pod, a facet of which faces the pod and intersects each of the outer pair of vertical stabilizing beams at a perpendicular angle.

### CROSS-REFERENCE TO RELATED APPLICATIONS

This application claims the benefit of, and priority to, U.S. Provisional Patent Application No. 62/296,461, filed on Feb. 17, 2016, the entire contents of which are incorporated herein by reference.

### BACKGROUND

### Technical Field

The present disclosure relates to energy conversion devices and, more particularly, to systems for converting energy from the wave patterns of a body of water into electrical energy.

### Description of Related Art

Significant effort has been expended on developing technologies able to utilize the earth's tremendous power. For centuries, devices such as windmills, watermills, hydro-turbines, geo-thermal heat generators, and solar energy panels have been developed and refined to capture and convert the earth's energy into electrical energy. However, even though over 70% of the earth's surface is covered by oceans, very little innovation has been developed capable of efficiently harnessing this vast power. It is estimated that ocean waves are capable of generating an energy flux between 10 kW and 80 kW per meter of coastline. Most importantly, this energy is generated on a nearly continuous basis, with little to no interruption as compared to solar or wind powered solutions. Accordingly, a need for an efficient, scalable, and cost efficient system for harnessing the power of the ocean's waves is needed.

### SUMMARY

A wave energy conversion system provided in accordance with the present disclosure includes a pod rotatably supported by a platform structure. The platform structure includes a horizontal stabilizing beam disposed in spaced relation to the pod and a plurality of vertical stabilizing beams arranged in a spaced apart configuration and configured to rotatably support the pod. The horizontal stabilizing beam is interposed between an outer pair of the plurality of vertical stabilizing beams opposite the pod. A facet of the horizontal stabilizing beam faces the pod and intersects each of the outer pair of vertical stabilizing beams at a perpendicular angle.

In aspects, a vertex of the horizontal stabilizing beam may be oriented in a direction facing away from the pod.

In other aspects, the system may include at least one mooring rod assembly rotatably coupled to the platform structure at a first end.

In certain aspects, the system may include a mooring anchor where the at least one mooring rod assembly is rotatably coupled to the mooring anchor at a second end.

In other aspects, the at least one mooring rod assembly may include an elongate member extending between first and second end portions, a first coupling member disposed on the first end portion, and a second coupling member disposed on the second end portion. The first and second coupling members may be configured to rotatably secure the elongate member to the platform structure at the first end portion and the mooring anchor at the second end portion.

In aspects, the mooring anchor may include a base, a stud rigidly affixed to the base and extending therefrom, and a coupling assembly slidably and rotatably disposed on the stud.

In certain aspects, the coupling assembly may include a housing and a bearing configured to slidably and rotatably receive the stud therein.

In other aspects, the housing may define a pair of opposed side surfaces having a corresponding pair of posts disposed thereon. Each of the pair of posts may be configured to rotatably couple a corresponding coupling member of the at least one mooring rod assembly.

In certain aspects, the system may include a barge coupled to the platform structure. In other aspects, the barge may include a hydraulically actuated electrical generation system disposed thereon that is operably coupled to the pod.

In aspects, the hydraulically actuated electrical generation system may include a hydraulic motor operably coupled to the pod and an electric generator operably coupled to the hydraulic pump via a hydraulic circuit.

In other aspects, the horizontal stabilizing beam may define a triangular profile. In aspects, the system may include a water pump operably coupled to the hydraulic motor. In certain aspects, the electric generator may be in fluid communication with the water pump via a hose.

In aspects, the system may include at least one bladder disposed on the mooring anchor that is configured to be inflated to flat the mooring anchor in water. In other aspects, the system may include a pneumatic hose in fluid communication with the at least one bladder that is configured to transmit air to the at least one bladder to inflate the at least one bladder with air. In certain aspects, the system may include a multi-radius energy transmission mechanism in mechanical communication with the pod. The multi-radius energy transmission mechanism may be in mechanical communication with the pod and may include a plurality of gears being rotatably supported at a point other than a centerpoint thereof. The plurality of gears may cooperate to provide increasing resistance to rotation of the pod as the pod is rotated in first direction.

In certain aspects, each gear of the plurality of gears may include an elliptical profile.

In other aspects, a radius of a first gear of the plurality of gears may increase and a radius of a second gear of the plurality of gears may decrease at a mesh point therebetween to provide increasing resistance to rotation of the pod as the pod is rotated in the first direction.

In aspects, the multi-radius energy transmission mechanism may be operably coupled to a hydraulically actuated electrical generation system.

### BRIEF DESCRIPTION OF THE DRAWINGS

Various aspects and features of the present disclosure are described hereinbelow with references to the drawings, wherein:

FIG. 1 is a perspective view of a system provided in accordance with the present disclosure capable of extracting energy from waves;

FIG. 1A is a cross-sectional view taken along section line 1A-1A of FIG. 1;

FIG. 2 is a perspective view of a portion of a pod of the system of FIG. 1;

FIG. 3 is a side view of the portion of the pod of FIG. 2;

FIG. 4 is a side view of a mooring rod assembly of FIG. 1;

FIG. 5 is side view of a mooring anchor of the system of FIG. 1;

FIG. 6 is a plan view of the mooring anchor of FIG. 5;

FIG. 7A is a side view of the pod of FIG. 2, shown in a static position and illustrating a multi-radius energy transmission mechanism disposed thereon;

FIG. 7B is a side view of the pod of FIG. 4, shown in a maximum rotational position;

FIG. 8 is a side view of a transmission of the system of FIG. 1;

FIG. 9 is an alternative embodiment of a transmission for the system of FIG. 1;

FIG. 10 is a perspective view of the system of FIG. 1 shown with the pod in an articulated position;

FIG. 11A is a side view of the system of FIG. 1, shown without a horizontal stabilizing beam of the platform structure;

FIG. 11B is a side view of the system of FIG. 1, shown with the horizontal stabilizing beam of the platform structure;

FIG. 11C is a side view of the system of FIG. 1, shown with a wave passing by the pod and platform structure;

FIG. 12 is a perspective view of an assembly of a plurality of pods;

FIG. 13 is a side view of the system of FIG. 1 including a shore based electric generation system; and

FIG. 14 is a schematic view of a hydraulically activated electrical generation system of FIG. 13.

### DETAILED DESCRIPTION

The present disclosure is directed to systems and methods of converting energy from wave patterns of a body of water into electrical energy. As described herein, the system includes a buoyant pod rotatably supported on a frame or platform structure that is submerged in water. The pod includes a generally tear drop or egg shaped profile and is capable of being rotated by passing waves. In this manner, as a wave contacts a windward surface of the pod, the pod is rotated and exposes a greater surface area against the wave to generate an increasing torque about a center of rotation of the pod.

To provide a reaction force against the increasing torque generated by rotation of the pod, a multi-radius energy transmission mechanism is disposed within the pod that is mechanically coupled to the pod and the platform structure. The platform structure includes a pair of vertical stabilizing beams, each rotatably supporting the pod at an upper portion thereof.

As can be appreciated, the buoyancy of the pod causes the pod to rise along with the crest of the wave. To alleviate this issue, the platform structure includes a generally triangular shaped stabilizing beam extending between each of the pair of vertical stabilizing beams. A planar facet of the stabilizing beam is oriented in a generally horizontal orientation (e.g., parallel to the seabed) such that a vertex of the triangular shape is pointing directly toward the seabed. The horizontal orientation of the facet of the stabilizing beam provides resistance against movement through the water in a vertical direction, tending to maintain the system at a generally fixed location as each wave passes by. By maintaining the position of the system, a greater surface area of a windward surface of the pod is engaged by the wave, thereby generating a greater amount of energy than if the pod were free to rise with each passing wave.

The system includes a pair of rigid mooring rods that couple the platform structure to a mooring anchor such that the platform structure is free to move in a vertical and/or radial direction, but not in a horizontal direction to and from the mooring anchor. The mooring rods inhibit slack from being formed within the connection between the platform structure and the mooring anchor. As can be appreciated, slack in this connection can introduced a period in which no electrical energy is generated, as the waves must first push the pod in a leeward direction until all the slack is removed in the mooring rod, and only then may the waves cause the pods to rotate. Therefore, additional energy is able to be extracted from passing waves using the rigid mooring rods described herein.

The system also includes a hydraulically actuated electrical generation system that is disposed on a barge, or in embodiments, partially on a barge and partially on land. The hydraulically actuated electrical generation system may utilize a comparatively smaller hydraulic circuit to drive a hydraulic motor, which in turn, drives a water pump. The water pump is used to drive an electrical generator disposed on shore and in fluid communication with the water pump via a hose.

Embodiments of the present disclosure are now described in detail with reference to the drawings in which like reference numerals designate identical or corresponding element in each of the several views. As used herein, the term “windward” will refer to the portion of the device or component thereof that is at the front or leading end thereof and the term “leeward” will refer to the portion of the device or component thereof that is at a back or trailing end thereof. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

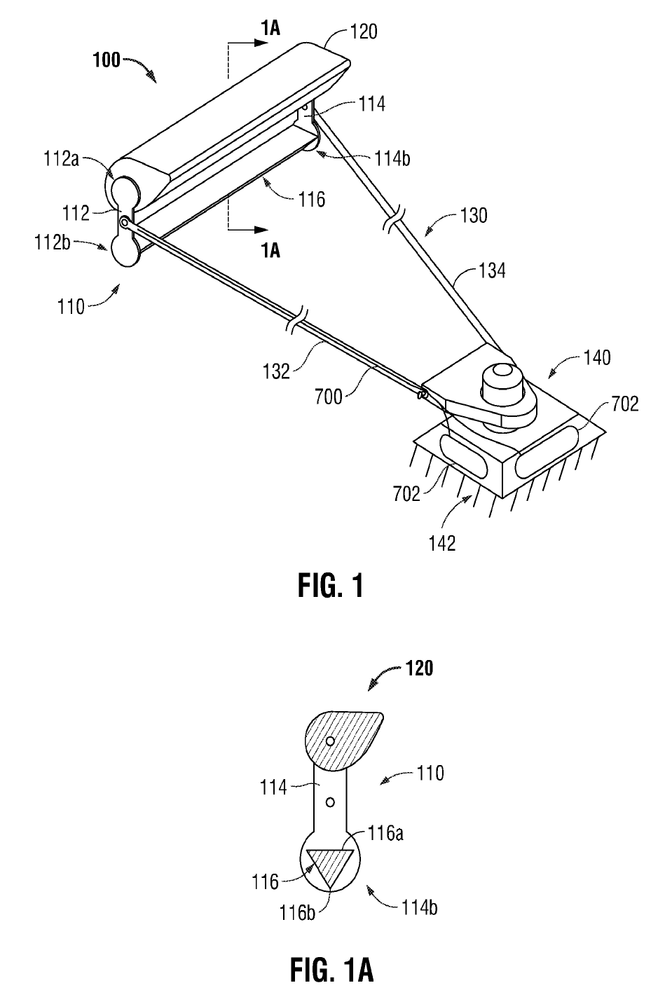

With reference to FIG. 1, a system provided in accordance with the present disclosure and configured for converting energy from the wave patterns of a body of water into electrical energy is shown and generally identified by reference numeral 100. System 100 generally includes a platform structure 110 which is configured to be submerged, either in part or in whole, within the ocean, one or more rotatable energy removing members or pods 120 rotatably supported by the platform structure, a mooring rod assembly 130, and a mooring anchor 140 mechanically coupled to the platform structure 110 by the mooring rod assembly 130. Although generally described herein as being used in the ocean, it is contemplated that the system 100 may be utilized in any body of water having waves.

Platform structure 110 includes a pair of vertical stabilizing beams 112 and 114 arranged in a spaced apart, parallel configuration, each defining a first end portion 112a, 114a at an upper portion thereof and a second end portion 112b, 114b opposite thereto at a lower portion thereof. In embodiments, the platform structure 110 may include additional stabilizing beams to provide additional support for the pod 120. A horizontal stabilizing beam 116 is interposed between each vertical stabilizing beam 112, 114 and fixedly coupled thereto at the second end portion 112b, 114b of each vertical stabilizing beam 112, 114. In embodiments, the horizontal stabilizing beam 116 may be affixed to a lower surface (e.g., an end surface adjacent the second end portion 112b, 114b of each vertical stabilizing beam 112, 114, respectively) and extend either flush or past each vertical stabilizing beam 112, 114.

As best illustrated in FIG. 1A, the horizontal stabilizing beam 116 defines a generally triangular profile, and in one non-limiting embodiment defines a triangular shape reminiscent of an equilateral triangle. As can be appreciated, the triangular profile of the horizontal stabilizing beam 116 may include various other triangular profiles, such as acute, oblique, isosceles, or the like depending upon the desired hydrodynamic characteristics of the platform structure, as will be described in further detail hereinbelow. In embodiments, the horizontal stabilizing beam may define any suitable shape having a broad surface on one end and a narrower surface disposed at an opposite end thereto, such as T-shaped, a planar surface and two arcuate surfaces (concave or convex), three arcuate surfaces, a generally trapezoidal shape, etc. or combinations thereof.

With continued reference to FIG. 1A, a facet 116a of the horizontal stabilizing beam 116 is oriented in a horizontal orientation such that the facet 116a intersects each vertical stabilizing beam 112, 114 at a perpendicular angle (e.g., the facet 116a is oriented generally parallel to the seabed). In this orientation, a vertex 116b of the horizontal stabilizing beam 116 disposed opposite the facet 116a is oriented in a manner such that the vertex 116b is pointing toward the seabed. The horizontal orientation of the facet 116a provides a large surface area upon which the water acts upon as the platform structure 110 is urged in a vertical direction (e.g., away from the seabed) by passing waves. In this manner, the surface area of the facet 116a provides resistance to movement of the platform structure 110 in a vertical direction and helps ensure the draft of the platform structure 110 remains substantially the same as each wave passes by the platform structure 110 (e.g., the draft of the platform structure does not change).

The location of the vertex 116b opposite to the facet 116a enables the platform structure to smoothly and quickly follow the profile of each wave as it passes through the platform structure. In contrast to the facet 116a, the vertex 116b penetrates water as the platform structure transitions into the trough of the wave and provides minimal resistance to water passing from the vertex 116b to the facet 116. As can be appreciated, as the platform structure 110 transitions from the trough to the crest of the wave, minimal vertical movement of the platform structure 110 is desired. However, as the platform structure 110 transitions from the crest to the trough of the wave, minimal resistance to vertical movement of the platform structure 110 is desired so that the platform structure can smoothly follow the profile of each wave and ensure the platform structure is in an optimal position to harvest maximum energy from the wave that follows.

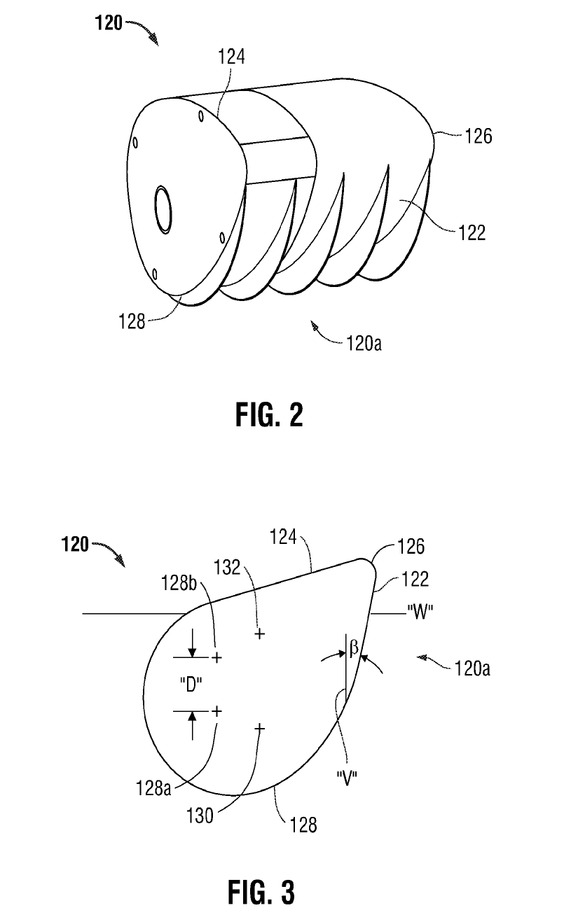

Turning now to FIGS. 2 and 3, the pod 120 includes a generally tear drop or egg shaped profile, although other suitable profiles are also contemplated depending upon the type of waves present at the end location or the needs of the system. The pod 120 includes a first planar side surface 122 and a second planar side surface 124 disposed in spaced relation to each other and oriented such that an upper end portion of each of the first and second planar side surfaces 122, 124 intersect to form an apex 126. Although generally shown as having an arcuate profile, the apex 126 may include any suitable profile such as pointed, planar, or the like. The first planar side surface 122 forms an angle β with respect to a vertical axis “V” of approximately 15 degrees, although other angles are also contemplated. Although generally shown as being disposed in a mirrored configuration, i.e., the first and second planar side surfaces 122, 124 form an equal angle with respect to an axis defined through the apex 126, it is contemplated that the first planar side surface 122 may diverge at a greater angle than the second planar side surface 124, or vice versa.

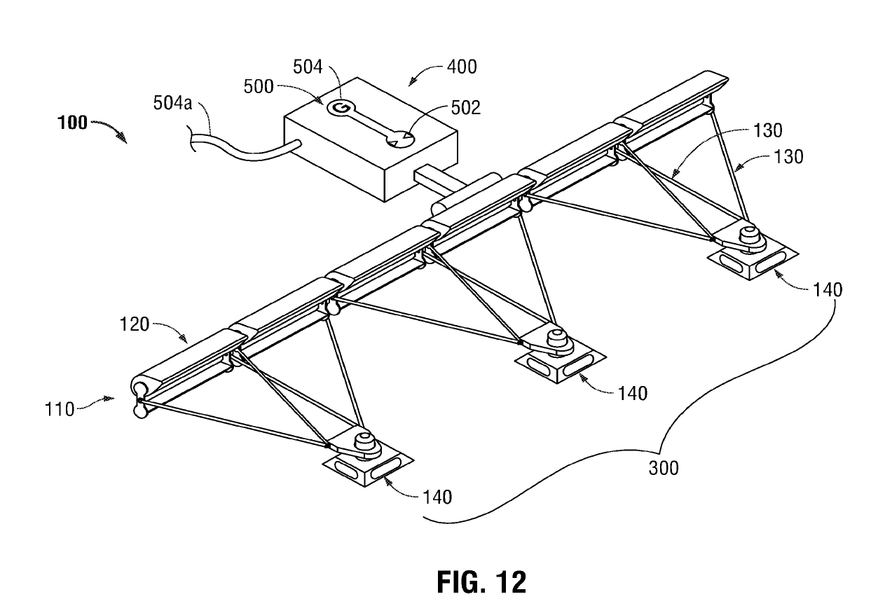

The first planar side surface 122 is disposed on a leading or windward side 120a of the pod 120 and transitions into a circular or arcuate profile 128 having a decreasing radius and extending towards and eventually joining the second planar side surface 124 disposed on a trailing or leeward side 120b of the pod 120. In this manner, the length of the first planar side surface 122 is shorter than that of the second planar side surface 124. As best illustrated in FIG. 3, the center of the initial radius of the arcuate profile 128 is located at point 128a and the final radius of the arcuate profile 128 is located at point 128b, located a distance “D” above point 128a that is ½ the initial radius of the arcuate profile 128. This configuration provides a centroid or center of gravity 130 that is below the center of rotation of the pod 120, which is located at point 128a of the pod 120. The geometry of the center of rotation 128a, the center of gravity 130, and the center of buoyancy 132 cooperate to cause the pod 120 to statically float in the water “W” such that the first planar side surface 122 intersects the water's surface at an angle of approximately 75 degrees (i.e., 15 degrees from vertical). It is contemplated, however, that the various geometries described above may be altered, depending upon the materials used to construct the pod 120, the mechanical elements disposed within the pod 120, and other considerations that impact the mass, buoyancy, and the location of the center of gravity of the pod 120. In embodiments, the platform structure 110 may support one more pods 120, such as two, three, four, or five pods 120. Each pod 120 may be mechanically coupled to one another or may be independently rotatable relative to each other. As can be appreciated, in instances where each pod 120 is mechanically coupled to one another, a single hydraulically actuated electrical generation system 500 (FIG. 12) is utilized. If each pod 120 is independently rotatably relative to one another, the system 100 includes a corresponding hydraulically actuated electrical generation system 500 for each pod 120. In embodiments, the system 100 includes an accumulator (not shown) that is hydraulically coupled to each pod 120 to store the fluid that is pressurized by each independently rotatable pod 120.

For a detailed description of an exemplary pod configured for use with the systems described within the present disclosure, reference can be made to U.S. Patent Application Publication No. 2015/0292472, filed Apr. 9, 2015 and titled “Wave Energy Conversion System,” the entire content of which is incorporated by reference herein.

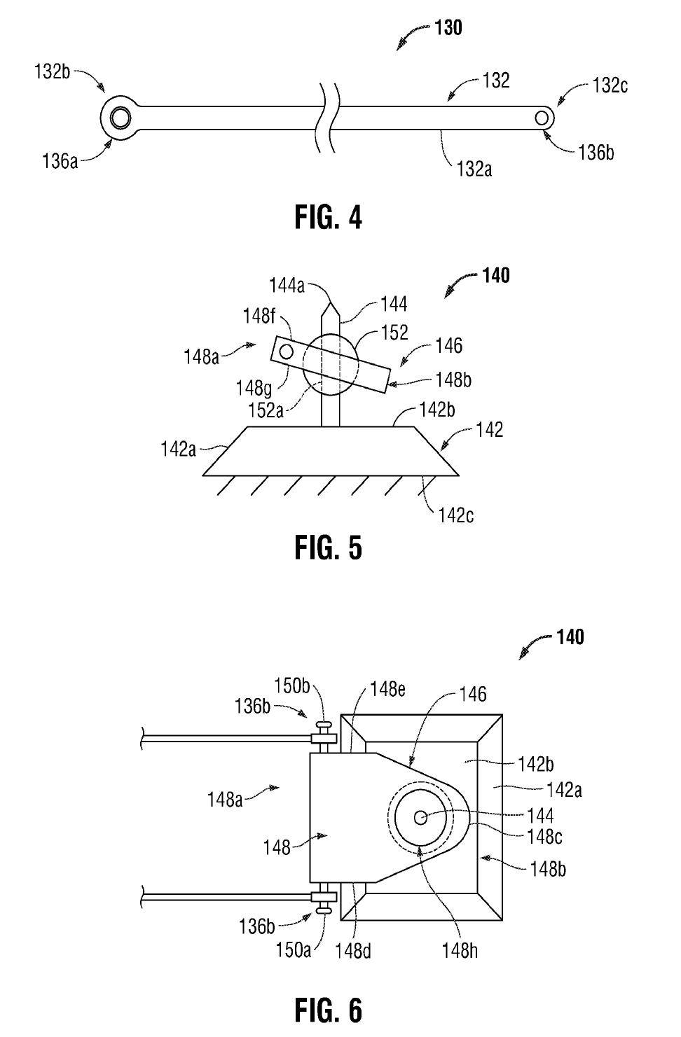

Referring to FIGS. 1 and 4, the mooring rod assembly 130 includes first and second mooring rods 132 and 134. The first and second mooring rods 132, 134 are substantially similar; thus, for purposes of brevity only the first mooring rod 132 will be described in detail hereinbelow. The first mooring rod 132 includes a rigid elongate member 132a extending between first and second end portions 132b and 132c and is neutrally buoyant or, in embodiments, slightly buoyant. It is also contemplated that the rigid elongate member 132a may not be buoyant. The first and second end portions 132b, 132c include a first and second coupling member 136a and 136b, respectively, coupled thereto. The first coupling member 136a is configured to rotatably couple the first end portion 132b of the elongate member 132a to the platform structure 110 and the second coupling member 136b is configured to rotatably couple the second end portion 132c of the elongate member 132a to the mooring anchor 140, as will be described in further detail hereinbelow.

It is contemplated that the first and second coupling members 136a, 136b may be any suitable coupling member, and in one non-limiting embodiment, the first coupling member 136a is a rod end bearing or spherical bearing and the second coupling member 136a is a plain bearing (e.g., a through hole formed through the second end portion 132c). The first and second coupling members 136a, 136b may be affixed to the elongate member 132a using any suitable means, such as welding, fasteners, press fit, or combinations thereof. Further, it is envisioned that the type of coupling utilized at for the first and second coupling members 136a, 136b may be the same or different. Specifically, it is contemplated that the first coupling member 136a may be a spherical bearing that is press fit, staked, or captured within a corresponding bore (not shown) that is defined through the first end portion 132b of the elongate member 132a and the second coupling member 136b may be a threaded rod end bearing that is threadably engaged to the second end portion 132c of the elongate member 132a to allow adjustment of the length of the first mooring rod 132. The first coupling member 132a be rotatably coupled to the vertical stabilizing beam 112 using any suitable means, such as a bolt, post, shoulder bolt, a fastener and tabs (e.g., a clevis) joined to the vertical stabilizing beam, or combinations thereof (not shown). In embodiments, where the platform structure 110 includes more than two vertical stabilizing beams, it is contemplated that the first coupling member 132a may be coupled to a vertical stabilizing beam that is centrally located on the platform structure 110.

As best illustrated in FIGS. 1, 5, and 6, the mooring anchor 140 includes a base portion 142, a stud portion 144 rigidly affixed to the base portion 142 and extending vertically therefrom, and a coupling assembly 146 slidably and rotatably disposed about the stud portion 144. The base portion 142 defines a generally cube shaped profile and may define tapered sides 142a such that the area of a top surface 142b is less than an opposed bottom surface 142c. As can be appreciated, the overall shape of the base portion may vary depending upon the needs of the location where the system 100 is installed (e.g., wave height and/or frequency will dictate the weight of the mooring anchor 140, the means in which the mooring anchor 140 is affixed to the seabed (if at all), etc.). The base portion 142 is formed from concrete, although it is contemplated that the base portion 142 may be formed from any material capable of being used in a salt environment, such as stainless steel, lead, etc. or combinations thereof.

The stud portion 144 defines a generally elongated cylindrical profile and is configured to be fixedly received within a bore (not shown) defined in the top surface 142b of the base portion 142 or may be cast into the base portion 142 as the base portion 142 is formed. In embodiments, the stud portion 144 may be affixed to the base portion 140 by casting, welding, threads, fasteners, friction fit, bonded, etc., or combinations thereof. A top portion of the stud portion 144 defines a tapered tip 144a to ease installation of the coupling assembly 146 thereon, although other configurations are also contemplated, such as planar, chamfered, rounded, or the like. The base portion 142 and the stud portion 144 cooperate to define an anchor point to which the coupling assembly 146 may be slidably and rotatably disposed, as will be described in further detail hereinbelow.

The coupling assembly 146 includes a housing portion 148 having a generally rectangular configuration, although other configurations are also contemplated. In one non-limiting embodiment, a first end portion 148a of the housing portion 148 defines a generally rectangular configuration and a second, opposite end portion 148b defines a generally trapezoidal configuration having an arcuate end surface 148c. The housing portion 148 defines opposed side surfaces 148d and 148e extending between the first and second end portions 148a, 148b. A portion of each of the side surfaces 148d, 148e adjacent the first end portion 148a includes a corresponding post 150a, 150b configured to engage the second coupling member 136b of the first and second mooring rods 132, 134, respectively. It is contemplated that each of the posts 150a, 150b may be a dowel, fastener (e.g., shoulder bolt, bolt, etc.), etc., or combinations thereof. In one non-limiting embodiment, the posts 150a, 150b may be a ball end post.

The housing portion 148 defines upper and lower surfaces 148f and 148g that extend between first and second end portions 148a, 148b and opposed side surfaces 148d, 148e. A bore 148h is defined through the upper and lower surfaces adjacent the second end portion 148b and is configured to receive a bearing portion 152. In embodiments, the bore 148h is concentric with the arcuate end surface 148c, although other configurations are also contemplated depending upon the needs of the system 100.

The bearing portion 152 is a spherical bearing or other similar device and is configured to be fixedly retained within the bore 148h. In this manner, the bearing portion defines a radial housing and an inner spherical ring rotatably secured within a cavity defined within the radial housing. The bearing portion is configured to be retained within the bore 148h using any suitable means, such as staking, snap ring, press fit, etc., or combinations thereof. In embodiments, the bearing portion 152 may omit a radial outer housing. Rather, the bore 148h defines an arcuate inner surface that is complementary to the outer surface of the bearing portion 152. It is contemplated that the bearing portion 152 may be retained within the bore 148h by any suitable means, and in embodiments, may be retained using a snap ring, press fit, etc., or combinations thereof.

The bearing portion 152 defines a bore 152a therethrough that is configured to slidably and rotatably receive the stud portion 144 of the mooring anchor 140. In this manner, the coupling assembly 146 is permitted to rotate about the stud portion 144 and translate up and down the stud portion 144 in response to passing waves, tidal changes, current direction, etc., as will be described in further detail hereinbelow.

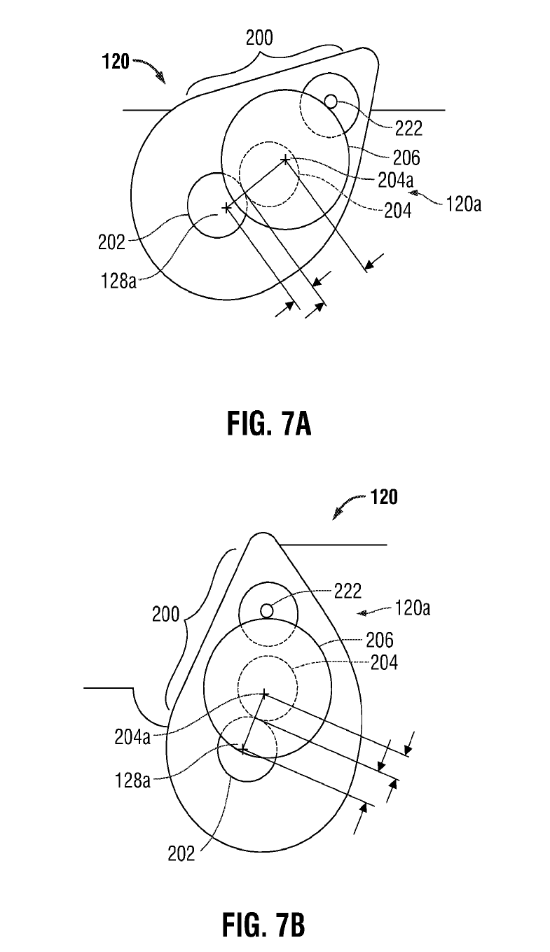

With reference to FIGS. 7A and 7B, when the pod 120 is in a first, static, position (FIG. 7A), passing waves impart a small amount of force upon the pod 120, thereby imparting a proportionally small amount of torque about point 128a. Therefore, the resistance against rotation about point 128a provided by the transmission 200 must be low in order to permit the pod 120 to rotate about point 128a and generate energy. As the pod 120 is caused to further rotate (FIG. 7B), the amount of force imparted by the passing waves increases with the amount of surface area of the windward side 120a of the pod 120 that is exposed, thereby increasing the amount of torque generated about point 128a until the pod 120 reaches a maximum angle of rotation (FIG. 7B) at which point the torque generated is at its maximum. Therefore, as the pod 120 is further rotated about point 128a from its static position, the resistance against rotation about point 128a provided by the transmission 200 must also increase. Thus, the greater the wave height and the longer the period of the wave energy, the further the pod 120 will rotate, and thus the greater the amount of counter torque will be required.

To provide a variable torque response as the pod 120 is caused to rotate about point 128a, the transmission 200 includes a plurality of gears rotatably and fixedly disposed therein. As illustrated in FIG. 7A, the transmission includes a drive gear 202 fixedly disposed on a driveshaft (not shown) extending through the center of rotation 128a of the pod 120, such that the pod 120 is rotatably supported thereon. The drive shaft is fixedly secured to the platform structure 110 and extends through the pod 120 to engage the drive gear 202. The drive gear 202 is secured to the drive shaft at a point other than the geometric center of the drive gear 202 such that the drive gear 202 remains stationary as the pod 120 rotates about the driveshaft. An intermediate or driven gear 204 is rotatably supported on a post or spindle (not shown) that is fixedly disposed within the pod 120. The drive gear 204 is rotatably supported on the post using any suitable means at a location 204a other than its geometric center. In this manner, the driven gear 204 rotates about the post in an eccentric manner as the driven gear 204 is caused to be rotated by drive gear 202 (e.g., in a planetary fashion). The eccentric rotation of the driven gear 204, coupled with the eccentric mounting of the drive gear 202, ensures that each of the driven gear 204 and the drive gear 202 remain in mechanical communication as the pod 120 is rotated. The relative centers of rotation of the drive gear 202 and the drive gear 204 remain constant as the pod 120 rotates about its center of rotation 120a while the torque transfer between the drive gear 202 and the driven gear 204 varies with continued rotation of the pod 120. Referring again to FIG. 7A, a spur gear 206 is rotatably supported on the same post that the driven gear 204 is supported on such that the spur gear 206 rotates about its geometric center. The spur gear 206 is fixedly secured to the driven gear 204 using any suitable means (e.g., bolted connection, nested configuration using friction fit, press fit, cogs, etc.), such that the spur gear 206 rotates in unison with the driven gear 204 (e.g., the torque from the driven gear 204 is imparted on the spur gear 206).

A pinion gear 222 in mechanical communication with a hydraulically actuated electrical generation system 500 and is disposed within the pod and is in mechanical cooperation with the spur gear 206, such that as the spur gear 206 is rotated, the pinion gear 222 is likewise rotated to cause the hydraulically actuated electrical generation system 500 to generate electric energy, as will be described in further detail hereinbelow.

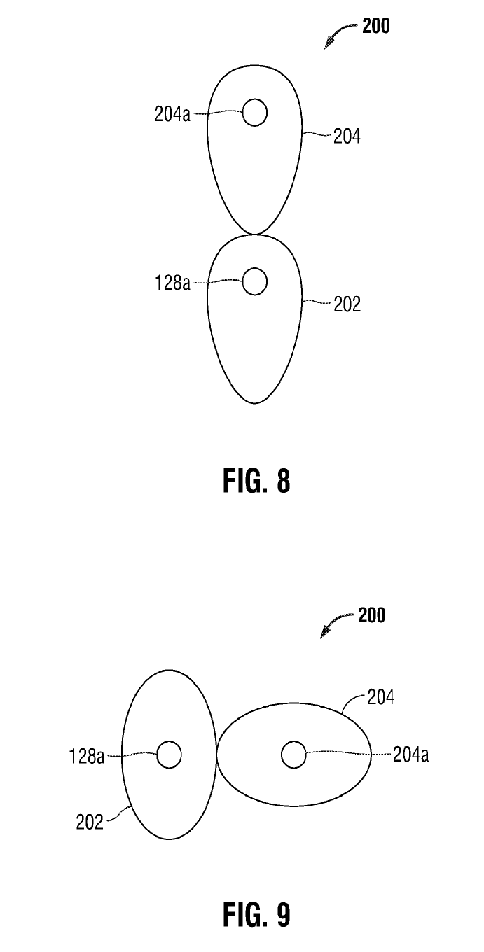

Although generally illustrated as being circular gears, it is contemplated that the drive gear 202 and the driven gear 204 may be elliptical or oblong gears (FIGS. 8 and 9). The use of elliptical gears enhances the ability of the drive gear 202 and the driven gear 204 to generate counter torque against the force imparted by passing waves on the pod 120. As can be appreciated, the elliptical gears may be rotatably supported at a center portion thereof or eccentrically supported.

For a detailed description of an exemplary transmission 200, reference can be made to U.S. Patent Application Publication No. 2015/0292472, filed Apr. 9, 2015 and titled “Wave Energy Conversion System,” previously incorporated by reference herein.

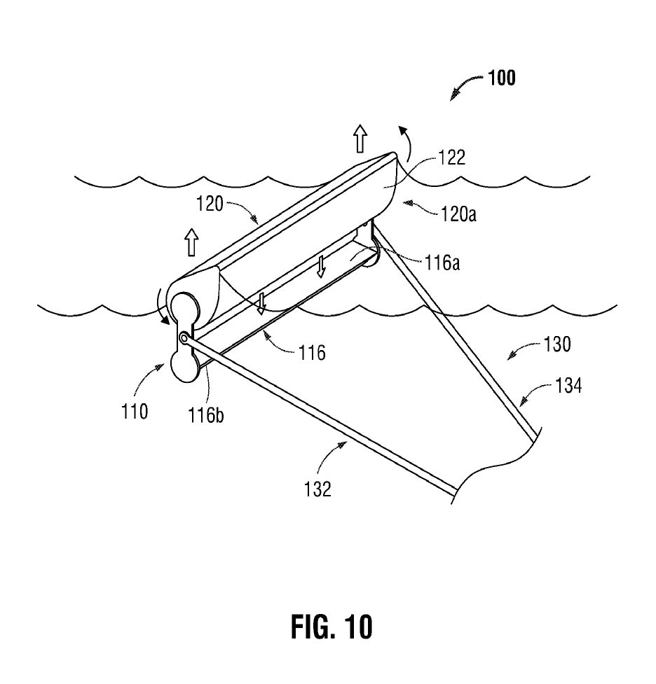

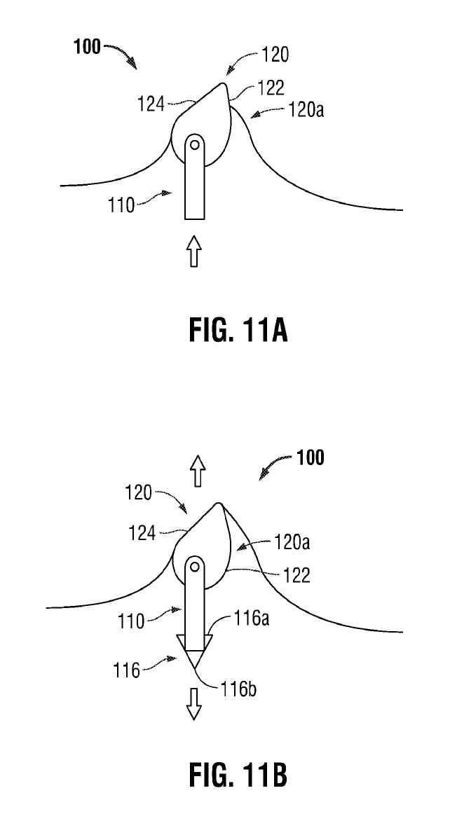

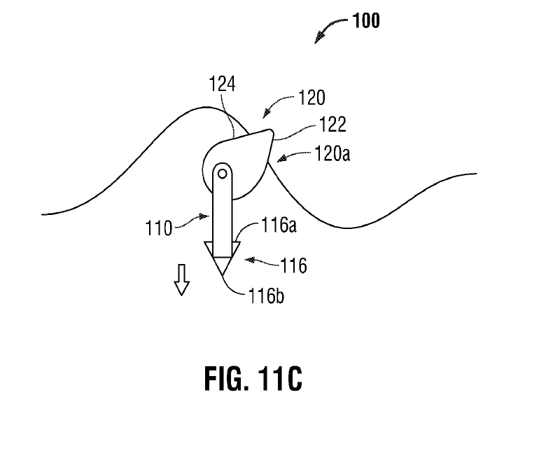

Turning now to FIGS. 10-11C, in use, the platform structure 110, the pod 120, the first and second mooring rods 132, 134, and the mooring anchor 140 (FIG. 1) cooperate to extract a maximum amount of energy from passing waves. Specifically, as a wave approaches the pod 120, the buoyancy of the pod 120 causes the pod 120 to rise along the profile of the wave up towards its crest. Further, the current of the passing waves drive the pod 120, and the platform structure 110 supporting the pod 120, away from the mooring anchor 140. The rigid first and second mooring rods 132, 134 substantially eliminate any slack or play in the coupling of the platform structure 110 and the mooring anchor 140 and ensure that the platform structure 110 remains substantially stationary in relation to the mooring anchor 140 in a horizontal direction. The facet 116a of the horizontal stabilizing beam 116 acts against the surrounding water and inhibits rapid movement of the platform structure in a vertical direction (e.g., towards the ocean surface). As the buoyancy of the pod 120 tends to raise the platform structure 110 along the profile of the wave, the facet 116a of the horizontal stabilizing beam 116 provides an enlarged surface area upon which the water acts to create drag on the platform structure 110. This drag substantially slows the rise of the platform structure 110 and the pod 120 such that the platform structure 110 and the pod 120 remain substantially stationary in a vertical direction as waves pass by. By remaining substantially stationary, a greater amount of surface area of the first planar side surface 122 of the pod 120 (e.g., the planar surface disposed on the windward side 120a of the pod 120) is impacted by passing waves. In particular, with reference to FIG. 11A, if the platform structure 110 and the pod 120 were permitted to rise along with the wave, only a portion of the first planar side surface 122 of the pod 120 is impacted by passing waves. In contrast, with reference to FIG. 11B, because the facet 116a of the horizontal stabilizing beam 116 inhibits vertical movement of the platform structure 110 and the pod 120, as the pod 120 rotates, the wave is able to impact a greater surface area of the first planar side surface 122 of the pod 120 due to the waterline of the pod 120 being lower than if the facet 116a were not present. As can be appreciated, because additional surface area of the first planar side surface 122 is impacted by passing waves, the pod 120 is able to be rotated by passing waves a greater amount than if the waterline of the pod 120 was higher (e.g., without the use of the horizontal stabilizing beam 116).

As illustrated in FIG. 11C, as the crest of the wave passes the pod 120 the pod 120 will fall into the trough of the passing wave. As described hereinabove, the vertex 116b of the horizontal stabilizing beam 116 enables the platform structure 110 and the pod 120 to smoothly and quickly sink such that the pod 120 may follow the profile of the wave as it passes therethrough. In other words, where the facet 116a inhibits vertical movement of the platform structure 110, the vertex 116b permits vertical movement of the platform structure 110. Therefore, the pod 120 is placed in a position most able to extract maximum energy from passing waves.

Referring again to FIGS. 1 and 4-6, the first and second coupling members 136a, 136b of the first and second mooring rods 132 and 134 enable the platform structure 110 to freely move in a vertical and/or radial direction (e.g., rotate about the stud portion 144 of the mooring anchor 140), but inhibit movement of the platform structure in a horizontal direction (e.g., toward or away from the mooring anchor 140). In this manner, the first and second mooring rods 132 and 134, in cooperation with the mooring anchor 140, permit minimal horizontal movement of the platform structure 110 (e.g., allow the platform structure to follow an arc defined by the radius of the first and second mooring rods 132, 134 in a vertical direction) or radial distance from the mooring anchor 140 in a circumferential direction (e.g., rotate about the mooring anchor 140), and by extension, passing waves. In this manner, the platform structure 110 is held substantially stationary as passing waves impact the pod 120 such that no energy is lost to drift (e.g., movement of the platform structure 120 in a leeward or windward direction). As can be appreciated, an ordinary tether, such as a rope, chain, cable, or the like, allows the pod 120 to move in a windward direction as waves impact and then travel past the pod 120. This windward movement causes the rope or chain to slack, which must be made up by leeward movement of the pod 120 as the wave initially impacts the pod 120. Therefore, as the wave impacts the pod 120, the pod 120 is pushed in a leeward direction instead of being rotated and extracting energy. In contrast, the rigid first and second mooring rods 132, 134 allow the pod to follow the profile of each passing wave without introducing slack. Therefore, the rigid first and second mooring rods 132, 134 enable the pod 120 to extract maximum energy from passing waves by focusing the energy of each wave on rotating the pod.

Although the system 100 is generally described as having a single platform structure 110, pod 120, mooring rod assembly 130, and mooring anchor 140, it is contemplated that the system 100 may include a plurality of platform structures 110, pods 120, mooring rod assemblies 130, and mooring anchors 140. As illustrated in FIG. 12, the system 100 includes a plurality of platform structures 110, pods 120, mooring rod assemblies 130, and mooring anchors 140 where the plurality of platform structures 110 are disposed end to end such that the plurality of platform structures 110 form a substantially straight line, although other orientations are also contemplated. Although generally illustrated has having three mooring anchors 140, it is contemplated that the system 100 may include as many mooring anchors as is necessary to maintain the platform structures 110 in place, such as one, two, four, five, etc. In embodiments, the system 100 may include seven platform structures 110, pods 120, and mooring rod assemblies 130 coupled together to form a pod assembly 300. As can be appreciated, the pod assembly 300 may include any number of platform structures 110, pods 120, and mooring rod assemblies 130. It is envisioned that a plurality of pod assemblies 300 may be utilized to create a pod farm or other similar array of pods 120 in order to extract additional energy from passing waves.

Turning now to FIG. 12, a barge 400 is coupled to the pod assembly 300 and is configured to support a hydraulically actuated electrical generation system 500 thereon. The barge 400 may be any suitable floating platform having the capability to float the weight of the hydraulically actuated electrical generation system 500 thereon without sinking, capsizing, or excessively listing in any direction. Cyclical rotation of the pod 120 caused by passing waves pressurizes hydraulic fluid within the hydraulically actuated electrical generation system 500 and drives a hydraulic motor 502. The hydraulic motor 502 is mechanically coupled to a suitable electric generator 504 which is configured to generate electric energy as the hydraulic motor 502 drives the electric generator 504. The electric energy generated by the electric generator 504 is transmitted to show using a suitable undersea cable 504a or the like.

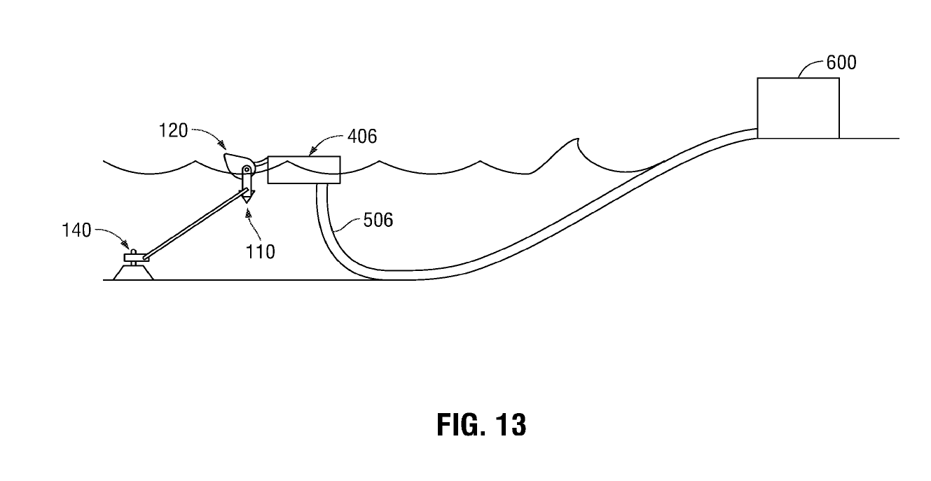

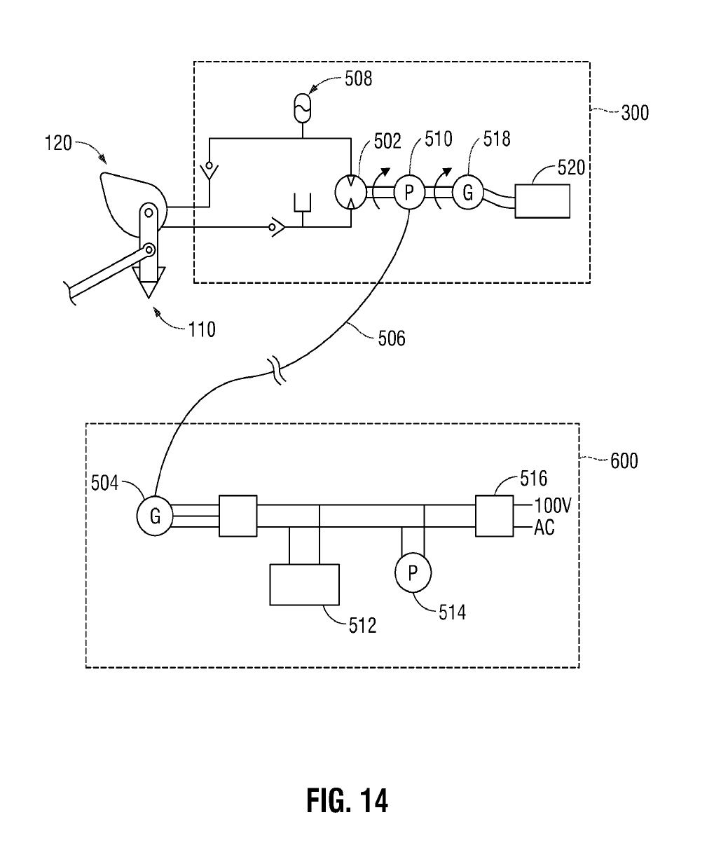

Referring to FIGS. 13 and 14, it is contemplated that only the hydraulic motor 502 may be located at sea such that the electric generator 504 is located on the shore. Specifically, the pod 120 is coupled to the hydraulic motor 502 that is configured to pump raw water (such as sea water) to the electric generator 504 located on shore in a generator housing 600 using a hose 506 or other suitable means for transporting high pressure water over a distance. The hose 506 is configured to lie on the seabed, and therefore is weighted using any suitable means. In this way, the hose 506 is kept out of the way of passing vessels, swimmers, wildlife, or the like, although it is contemplated that the hose may float or be embedded in the sea floor, depending upon the need and requirements of the location at which the system 100 is installed. In embodiments, an accumulator 508 (FIG. 14) is interposed between the hydraulic motor 502 and the pod 120 on the return side of the hydraulic circuit.

The electric generator 504 is in fluid communication with a water pump 510 that is coupled to the hydraulic motor 502 and pushes water through the hose 506 such that the raw water pressurized therein causes the electric generator 504 to rotate and generate electrical energy. In embodiments, the water pump 510 may be a hydraulic pump. The electric generator 504 is configured to generate 3-phase direct current (DC) electrical energy, although it is contemplated that the electric generator may be configured to generate single phase DC or alternating current (AC) electrical energy. The electric generator 504 is electrically coupled to a battery 512, a second water pump 514, and an inverter 516. The battery 512 is configured to store energy generated by the electric generator 504. The second water pump 514 is in fluid communication with the hose 506 and is configured to boost the water pressure within the hose 506 to provide additional hydraulic power to the electric generator 504 to produce more electrical energy. It is contemplated that the second water pump 514 may be used to pump water to an accumulator (not shown) disposed on shore that is configured to store raw water. In this manner, the accumulator can act in a similar matter to the accumulator 508 on the seaboard side of the hydraulically actuated electrical generation system 500. As can be appreciated, the second water pump 514 may be a hydraulic pump.

The inverter 516 is disposed on shore and is configured to transform the DC 3-phase electrical energy generated by the electric generator 504 into 110 volt AC power for consumer use. In embodiments, the inverter 516 may transform the DC 3-phase electrical energy into 220 volt AC power or DC power, depending on the needs of the consumer.

The hydraulically actuated electrical generation system 500 may include a second electric generator 518 disposed on the barge 300 that is mechanically coupled to either the hydraulic motor 502 or the second water pump 514. The second electric generator 518 is electrically coupled to one or more batteries 520 disposed on the barge 300.

Although generally described as being an open loop seawater system, it is contemplated that a closed loop oil-based hydraulic system may be utilized. Additionally, it is envisioned that the electric generator 504 may be used in conjunction with, or replaced, by a compressor and pneumatic tank that can be pressurized to a desired pressure to run a pneumatic generator.

For exemplary hydraulically actuated electrical generation systems for use with the systems described herein, reference may be made to U.S. Patent Application Publication No. 2015/0292472, filed Apr. 9, 2015 and titled “Wave Energy Conversion System,” previously incorporated by reference herein.

The system 100 includes one or more air lines 700 in pneumatic communication with one or more bladders 702 (FIG. 1) disposed on the base portion 142 of the mooring anchor 140 at a first end and an air pump (not shown) disposed on the barge 300 at a second end, although it is contemplated that the air pump may be disposed on the platform structure 110. The air lines 700, the bladders 702, and the air pump cooperate to selectively raise the mooring anchor 140 off the sea bed. As can be appreciated, in the case of inclement weather, when the system 100 needs to be re-located, or when the system 100 needs maintenance to be performed thereon, the air pump may be activated to pump air through the air lines 700 and into the bladders 702. As the bladders are inflated, the buoyant force of the bladders 702 cause the mooring anchor 140 to rise off the sea bed, allowing the system 100 to be moved. It is contemplated that a buoy, flag, or other device capable (not shown) of indicating the location of the mooring anchor at sea level may be coupled to the mooring anchor 140.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A wave energy conversion system, comprising:
a pod rotatably supported by a platform structure, the platform structure including:
a horizontal stabilizing beam disposed in spaced relation to the pod; and
a plurality of vertical stabilizing beams arranged in a spaced apart configuration and configured to rotatably support the pod, wherein the horizontal stabilizing beam is interposed between an outer pair of the plurality of vertical stabilizing beams opposite the pod, a facet of the horizontal stabilizing beam facing the pod and intersecting each of the outer pair of vertical stabilizing beams at a perpendicular angle.

2. The system according to claim 1, wherein a vertex of the horizontal stabilizing beam is oriented in a direction facing away from the pod.

3. The system according to claim 1, further including at least one mooring rod assembly rotatably coupled to the platform structure at a first end.

4. The system according to claim 3, further including a mooring anchor, wherein the at least one mooring rod assembly is rotatably coupled to the mooring anchor at a second end.

5. The system according to claim 4, wherein the at least one mooring rod assembly includes:
an elongate member extending between first and second end portions;
a first coupling member disposed on the first end portion; and
a second coupling member disposed on the second end portion,
wherein the first and second coupling members are configured to rotatably secure the elongate member to the platform structure at the first end portion and the mooring anchor at the second end portion.

6. The system according to claim 4, wherein the mooring anchor includes:
a base;
a stud rigidly affixed to the base and extending therefrom; and
a coupling assembly slidably and rotatably disposed on the stud.

7. The system according to claim 6, wherein the coupling assembly includes:
a housing; and
a bearing configured to slidably and rotatably receive the stud therein.

8. The system according to claim 7, wherein the housing defines a pair of opposed side surfaces having a corresponding pair of posts disposed thereon, each of the pair of posts configured to rotatably couple a corresponding coupling member of the at least one mooring rod assembly.

9. The system according to claim 1, further including a barge coupled to the platform structure.

10. The system according to claim 9, wherein the barge includes a hydraulically actuated electrical generation system disposed thereon operably coupled to the pod.

11. The system according to claim 10, wherein the hydraulically actuated electrical generation system includes:
a hydraulic motor operably coupled to the pod; and
an electric generator operably coupled to the hydraulic pump via a hydraulic circuit.

12. The system according to claim 1, wherein the horizontal stabilizing beam defines a triangular profile.

13. The system according to claim 11, further including a water pump operably coupled to the hydraulic motor.

14. The system according to claim 13, wherein the electric generator is in fluid communication with the water pump via a hose.

15. The system according to claim 4, further including at least one bladder disposed on the mooring anchor, the at least one bladder configured to be inflated to float the mooring anchor in water.

16. The system according to claim 15, further including a pneumatic hose in fluid communication with the at least one bladder, the pneumatic hose configured to transmit air to the at least one bladder to inflate the at least one bladder with air.

17. The system according to claim 1, wherein the system includes a multi-radius energy transmission mechanism in mechanical communication with the pod, the multi-radius energy transmission mechanism including a plurality of gears being rotatably supported at point other than a centerpoint thereof, the plurality of gears cooperating to provide increasing resistance to rotation of the pod as the pod is rotated in a first direction.

18. The system according to claim 17, wherein each gear of the plurality of gears includes an elliptical profile.

19. The system according to claim 17, wherein a radius of a first gear of the plurality of gears increases and a radius of a second gear of the plurality of gears decreases at a mesh point therebetween to provide increasing resistance to rotation of the pod as the pod is rotated in the first direction.

20. The system according to claim 18, wherein the multi-radius energy transmission mechanism is operably coupled to a hydraulically actuated electrical generation system.
